(19) United States
(12) Patent Application Publication
(10) Pub. No.: US 2004/0201298 A1
(43) Pub. Date: Oct. 14, 2004

(54) Combination of a base and an axle tube for a fan motor

(75) Inventors: Alex Horng, Kaohsiung (TW); Yin-Rong Horng, Kaohsiung (TW); Ching-Sheng Hong, Kaohsiung (TW)

Correspondence Address: BACON & THOMAS, PLLC, 625 SLATERS LANE, FOURTH FLOOR, ALEXANDRIA, VA, 22314

(73) Assignee: Sunonwealth Electric Machine Industry Co., Ltd., Kaohsiung (TW)

(21) Appl. No.: 10/411,256

(22) Filed: Apr. 11, 2003

(51) Int. Cl. H02K 5/00

(52) U.S. Cl. 310/91

(57) ABSTRACT

A combination includes a casing having a base extending therefrom and an axle tube. The base has an axial hole, and at least one engaging portion is defined in an underside of the casing. The axle tube has at least one positioning portion on an end thereof. The axle tube is extended through the axial hole of the base, with the positioning portion of the axle tube being securely engaged with the engaging portion of the base. When an axle tube of different inner diameter or length is required, only an additional mold for the axle tube is required. It is not necessary to manufacture a mold for the whole casing.

### BACKGROUND OF THE INVENTION

1. Field of the Invention

The present invention relates to a combination of a base and an axle tube for a fan motor. In particular, the present invention relates to a combination of a base and an axle tube for a fan motor, wherein the axle tube that rotatably holds a shaft of the motor is securely engaged with the base formed on a casing of the motor.

2. Description of Related Art

FIG. 1 of the drawings illustrates another conventional structure of a base and ax axle tube for a fan motor. Such a structure is disclosed in, e.g., Taiwan Utility Model Publication No. 236471 entitled “STATOR STRUCTURE FOR A MINIATURE HEAT-DISSIPATING FAN”. As illustrated in FIG. 1, the base 10 is formed on a casing 1 and includes an axial hole 101. The axle tube 11 is made of metal and includes a lip 11a on an upper end thereof. A lower portion of the axle tube 11 is tightly engaged with the axial hole 101 of the base 10, and an outer periphery of the axle tube 11 is tightly engaged in a central hole (not labeled) of a stator 13. The stator 13 is retained on the base 10 by the lip 11a of the axle tube 11.

It is difficult to manufacture the axle tube 11 and the axial hole 101 that are to be engaged with each other through tight fitting. In a case that a central axis of the axle tube 11 is not coincident with that of the axial hole 101, either the axle tube 11 is not positioned along the central axis of the axial hole 101 or the base 10 deforms along a radial direction during the tight fitting of the axle tube 11 into the axial hole 101. As a result, a reliable engagement could not be obtained for the axle tube 11. Noise is generated when a rotor's shaft mounted in the axle tube 11 turns, and the life of the motor is shortened.

FIG. 2 of the drawings illustrates a miniature D.C. fan having a further conventional structure of a base and ax axle tube for a fan motor. Such a structure is disclosed in, e.g., U.S. Pat. No. 5,267,842. As illustrated in FIG. 2, the miniature D.C. fan includes a casing 1, a base 10, and an axle tube 11. The base 10 is made of plastics and supported by a plurality of ribs of the casing 1, and the axle tube 11 is integrally formed with the base 10. The axle tube 11 includes a plurality of shoulders 11b, 11c, and 11d for tightly engaging with a stator 13, a circuit board 12, and at least one bearing 14 (preferably ball bearing), respectively.

Although the structures shown in FIG. 2 avoids the above-mentioned problems, since the axle tube 11 is integrally formed with the casing 1, an additional mold is required for the casing 1 with the axle tube 11 if the dimension such as the inner diameter, length, etc. of the axle tube 11 changes. As a result, a manufacturer must prepare many molds for casings of various sizes. This causes problems to manufacture and management. The number of disqualified products as well as the cost is increased.

### OBJECTS OF THE INVENTION

An object of the present invention is to provide a combination of a base and an axle tube for a fan motor, wherein the axle tube is easily, securely mounted on the base of the casing of a motor. When an axle tube of different inner diameter or length is required, only an additional mold for the axle tube is required. It is not necessary to manufacture a mold for the whole casing. The overall cost for production is thus reduced.

### SUMMARY OF THE INVENTION

To achieve the aforementioned objects, the present invention provides a combination of a base and an axle tube for a fan motor, comprising:

a casing including a base extending therefrom, the base having an axial hole, at least one engaging portion being defined in an underside of the casing; and

an axle tube including an axial hole, the axle tube further including at least one positioning portion on an end thereof, the axle tube being extended through the axial hole of the base, with said at least one positioning portion of the axle tube being engaged with said at least one engaging portion of the base.

The positioning portion of the axle tube is securely engaged with the engaging portion of the casing. When an axle tube of different inner diameter or length is required, only an additional mold for the axle tube is required. It is not necessary to manufacture a mold for the whole casing.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a conventional combination of a base and an axle tube;

FIG. 2 is a sectional view of a conventional D.C. fan;

FIG. 3 is an exploded perspective view of a first embodiment of a combination of a base and an axle tube in accordance with the present invention;

FIG. 4 is a sectional view of the base and the axle tube of FIG. 3 after assembly;

FIG. 5 is a sectional view of a fan motor using the base and the axle tube of FIG. 3;

FIG. 6 is an exploded perspective view of a second embodiment of the combination of a base and an axle tube in accordance with the present invention;

FIG. 7 is a sectional view of the base and the axle tube of FIG. 6 after assembly;

FIG. 8 is a sectional view of a fan motor using the base and the axle tube of FIG. 6;

FIG. 9 is an exploded perspective view of a third embodiment of the combination of a base and an axle tube in accordance with the present invention;

FIG. 10 is a sectional view of the base and the axle tube of FIG. 9 after assembly;

FIG. 11 is a sectional view of a fan motor using the base and the axle tube of FIG. 9;

FIG. 12 is an exploded perspective view of a fourth embodiment of the combination of a base and an axle tube in accordance with the present invention;

FIG. 13 is a sectional view of the base and the axle tube of FIG. 12 after assembly;

FIG. 14 is a sectional view of a fan motor using the base and the axle tube of FIG. 13;

FIG. 15 is an exploded perspective view of a fifth embodiment of the combination of a base and an axle tube in accordance with the present invention; and

FIG. 16 is a top view of the base and the axle tube of FIG. 15 after assembly.

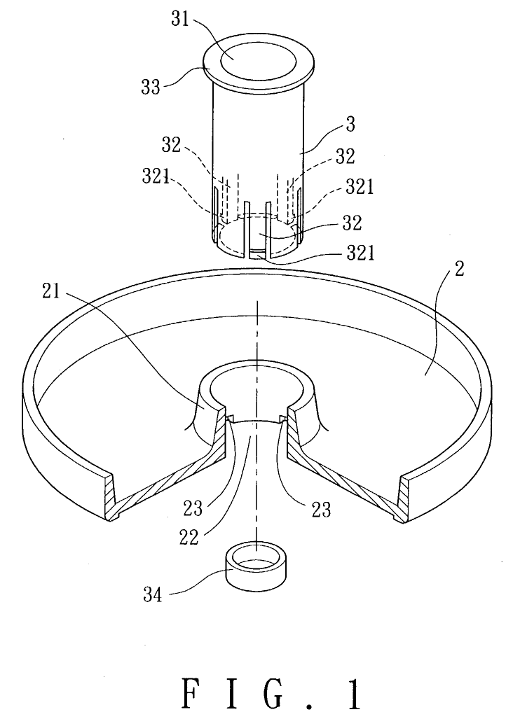

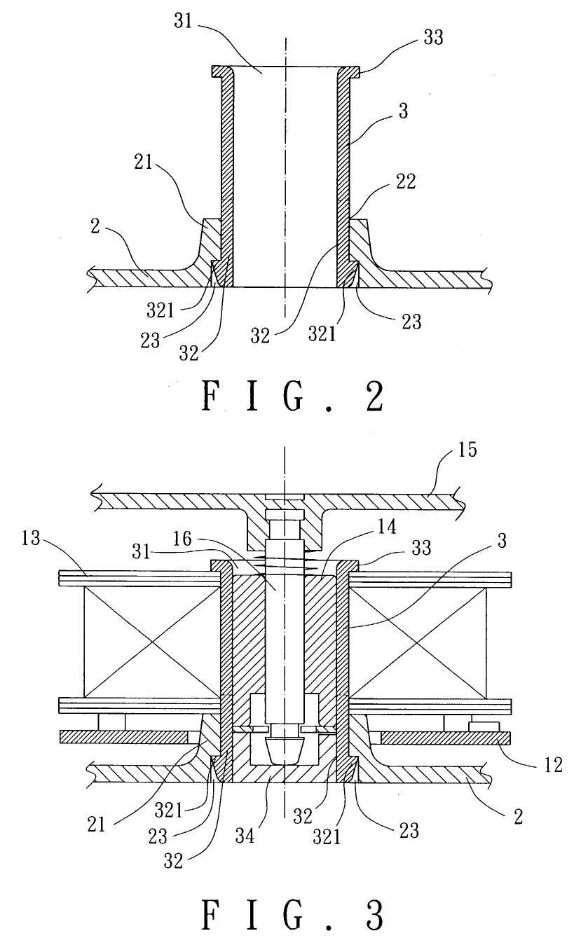

### DETAILED DESCRIPTION OF THE PREFERRED EMBODIMENTS

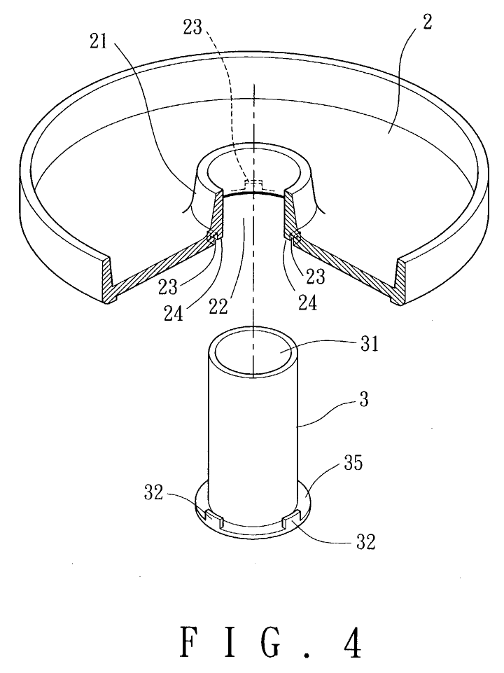

FIGS. 3 through 5 show a first embodiment of a combination of a base and an axle tube in accordance with the present invention. The first embodiment of the present invention includes a casing 2 and an axle tube 3. The casing 2 includes a base 21 projecting from a general plane of the casing 2 and extending along an axial direction perpendicular to the general plane. The base 21 has an axial hole 22 that has at least one engaging portion 23 (three in this embodiment) on a bottom thereof. In this embodiment, each engaging portion 23 is in the form of a notch in an underside of the casing 2.

The axle tube 3 is made of plastic or metal and has an axial hole 31. At least one positioning portion 32 (three in this embodiment) is provided on an end of the axle tube 3. A flange 33 is formed on the other end of the axle tube 3. The flange 33 may be integrally formed with the axle tube 3. Alternatively, the flange 33 can be formed by means of punching the end of the axle tube 3 after the axle tube 33 is engaged in the axial hole 22 of the base 2.

Each positioning portion 32 of the axle tube 3 is engaged with the associated engaging portion 23 of the base 21. In this embodiment, each positioning portion 32 of the axle tube 3 is in the form of a resilient rod 32 having a hook 321 for engaging with the associated engaging portion 23 (in the form of a notch) of the casing 2. Thus, the axle tube 3 is securely positioned in the axial hole 22 of the casing 2, best shown in FIG. 4. A support member 34 may be inserted into the axial hole 31 of the axle tube 3. The support member 34 abuts against an inner periphery delimiting the axial hole 31 of the axle tube 3 to thereby prevent the positioning portions 32 of the axle tube 3 from moving radially inward. Thus, the hook 321 of each positioning portion 32 is reliably engaged with the associated engaging portion 23 on the underside of the casing 2, preventing the positioning portions 32 of the axle tube 3 from disengaging the casing 2. In this embodiment, each resilient rods 112 is formed by means of providing two spaced apart longitudinally slits (not labeled) in the periphery of the axle tube 3.

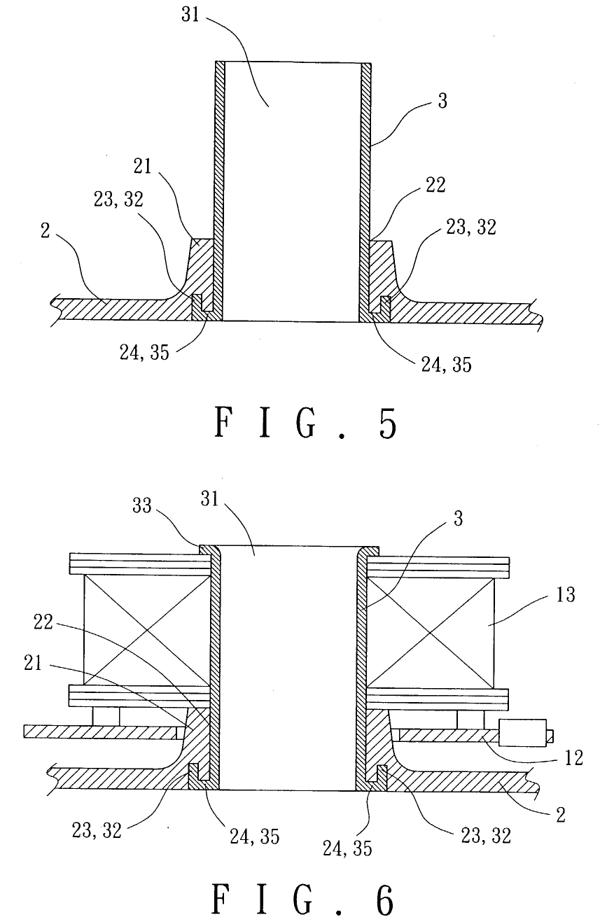

Referring to FIG. 5, after the axle tube 3 is engaged with the base 21, a conventional circuit board 12 is mounted around the base 21, and a conventional stator 13 is mounted around the axle tube 3. Further, a conventional bearing 14 and the above-mentioned support member 34 are mounted in the axial hole 31 of the axle tube 3. The flange 33 on top of the axle tube 3 prevents the stator 13 from being disengaged from the axle tube 3, providing a more reliable positioning effect for the axle tube 3. As mentioned above, the flange 33 may be integrally formed with the axle tube 3. Alternatively, the flange 33 can be formed by means of punching the upper end of the axle 3 after the circuit board 12 and the stator 13 are mounted. A distal end of a shaft 16 of a rotor 15 rests on the support member 34, providing a more stable rotation for the shaft 16 while providing a reliable positioning between the axle tube 3 and the axial hole 22 of the casing 2.

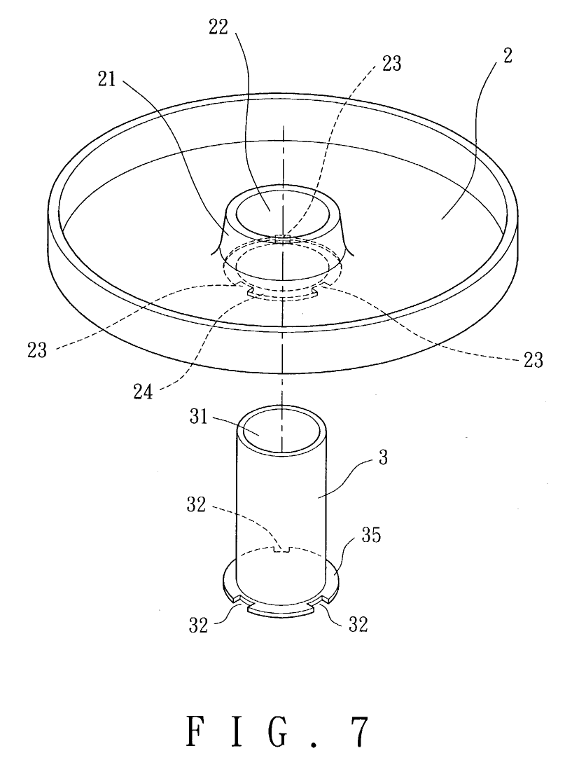

FIGS. 6 through 8 show a second embodiment of a combination of a base and an axle tube in accordance with the present invention, wherein like reference numerals designate like elements.

The second embodiment of the present invention includes a casing 2 and an axle tube 3. The casing 2 includes a base 21 projecting from a general plane of the casing 2 and extending along an axial direction perpendicular to the general plane. The base 21 has an axial hole 22. The casing 2 further has a countersink 24 in an underside thereof, the countersink 24 surrounding the axial hole 22 of the base 21. Further, at least one groove 23 (three in this embodiment) is defined in a bottom wall delimiting the countersink 24 and extends upward. Each groove 23 forms an engaging portion 23.

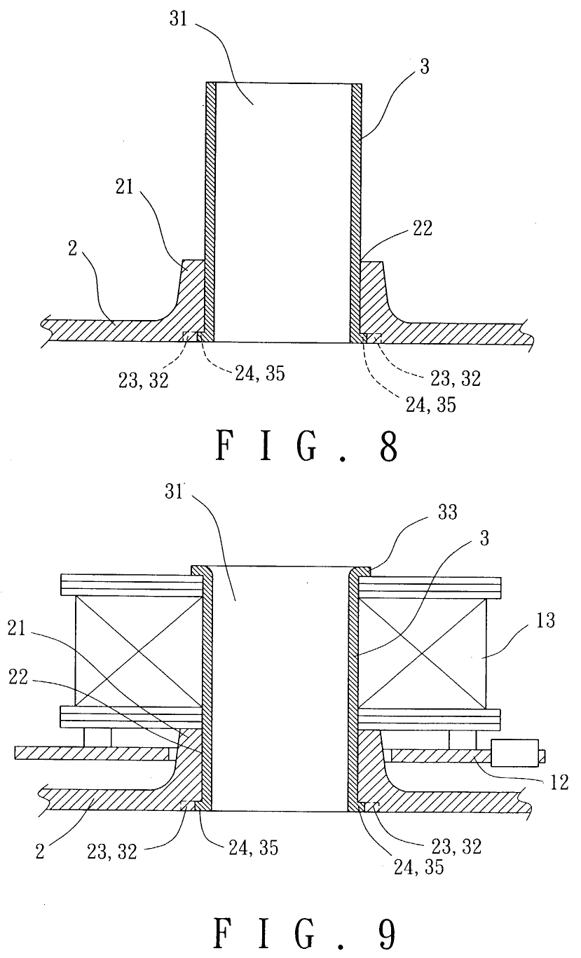

The axle tube 3 is made of plastic or metal and has an axial hole 31. At least one positioning portion 32 (three in this embodiment) is provided on an end of the axle tube 3 for engaging with the associated engaging portion 23 on the underside of the casing 2. In this embodiment, an extension 35 extends radially outward from a lower end of the axle tube 3 and is securely engaged with the countersink 24 of the casing 2. In this embodiment, each positioning portion is in the form of a protrusion 32 on a side of the extension 35. Each protrusion 32 is engaged in the associated groove 23 of the casing 2, thereby securely positioning the axle tube 3 in the base 21 of the casing 2, as shown in FIG. 7. If necessary, bonding agent can be used to improve the engagement between the axle tube 3 and the casing 2. Alternatively, tight fitting can be used.

Referring to FIG. 8, after the axle tube 3 is engaged with the base 21, a conventional circuit board 12 is mounted around the base 21, and a conventional stator 13 is mounted around the axle tube 3. Further, a conventional bearing 14 and the above-mentioned support member 34 are mounted in the axial hole 31 of the axle tube 3. Further, a flange 33 can be formed on top of the axle tube 3 to prevent the stator 13 from being disengaged from the axle tube 3 and to provide a more reliable positioning effect for the axle tube 3.

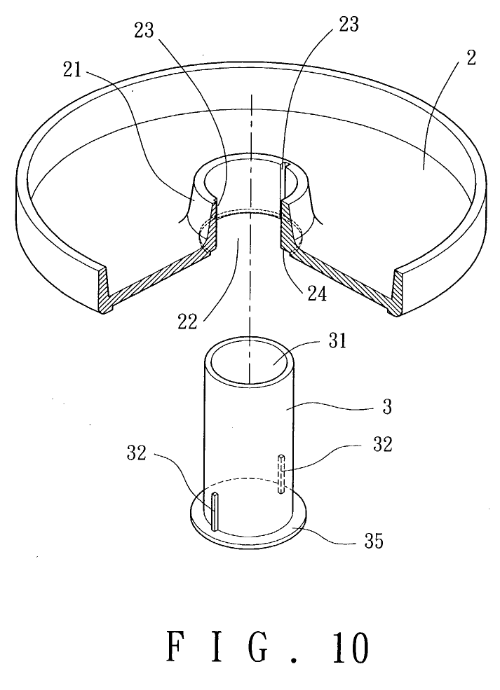

FIGS. 9 through 11 show a third embodiment of a combination of a base and an axle tube in accordance with the present invention, wherein like reference numerals designate like elements.

The third embodiment of the present invention includes a casing 2 and an axle tube 3. The casing 2 includes a base 21 projecting from a general plane of the casing 2 and extending along an axial direction perpendicular to the general plane. The base 21 has an axial hole 22. The casing 2 further has a countersink 24 in an underside thereof, the countersink 24 surrounding the axial hole 22 of the base 21. Further, at least one protrusion 23 (three in this embodiment) projects from a peripheral wall delimiting the countersink 24 and extends radially inward. Each protrusion 23 forms an engaging portion 23.

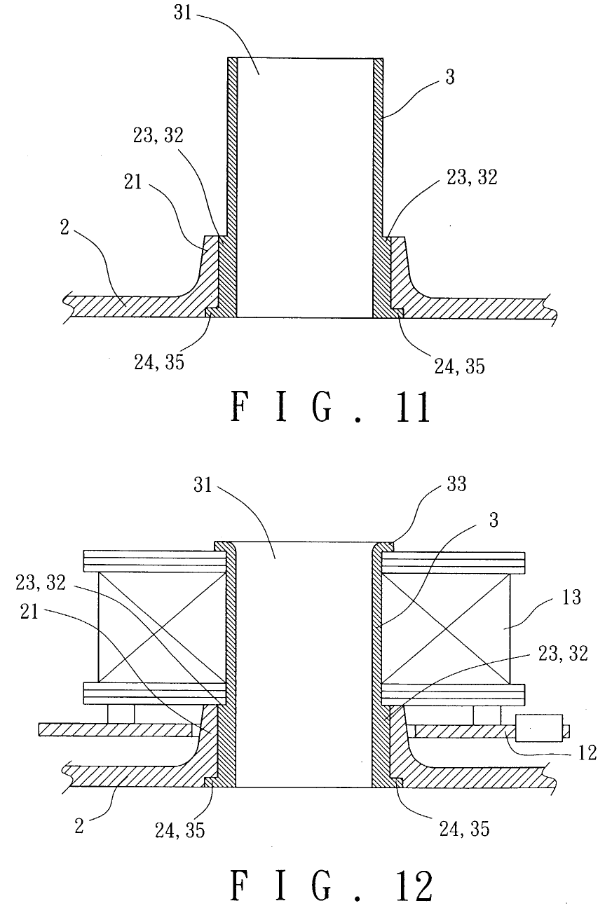

The axle tube 3 is made of plastic or metal and has an axial hole 31. At least one positioning portion 32 (three in this embodiment) is provided on an end of the axle tube 3 for engaging with the engaging portion 23 on the underside of the casing 2. In this embodiment, an extension 35 extends radially outward from a lower end of the axle tube 3 and is securely engaged with the countersink 24 of the casing 2. In this embodiment, each positioning portion is in the form of a notch 32 in the extension 35. Each protrusion 23 of the casing 2 is engaged in the associated notch 32 of the axle tube 3, thereby securely positioning the axle tube 3 in the base 21 of the casing 2, as shown in FIG. 10. If necessary, bonding agent can be used to improve the engagement between the axle tube 3 and the casing 2. Alternatively, tight fitting can be used.

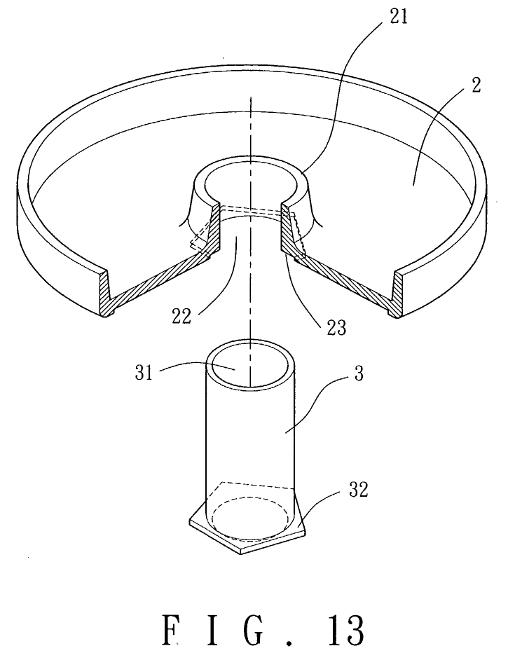

Referring to FIG. 11, after the axle tube 3 is engaged with the base 21, a conventional circuit board 12 is mounted around the base 21, and a conventional stator 13 is mounted around the axle tube 3. Further, a conventional bearing 14 and the above-mentioned support member 34 are mounted in the axial hole 31 of the axle tube 3. Further, a flange 33 can be formed on top of the axle tube 3 to prevent the stator 13 from being disengaged from the axle tube 3 and to provide a more reliable positioning effect for the axle tube 3.

FIGS. 12 through 14 show a fourth embodiment of a combination of a base and an axle tube in accordance with the present invention, wherein like reference numerals designate like elements.

The fourth embodiment of the present invention includes a casing 2 and an axle tube 3. The casing 2 includes a base 21 projecting from a general plane of the casing 2 and extending along an axial direction perpendicular to the general plane. The base 21 has an axial hole 22. The casing 2 further has a countersink 24 in an underside thereof, the countersink 24 surrounding the axial hole 22 of the base 21. Further, at least one longitudinal groove 23 (two in this embodiment) is defined in an inner periphery delimiting the axial hole 22 of the base 2. Each longitudinal hole 23 forms an engaging portion 23.

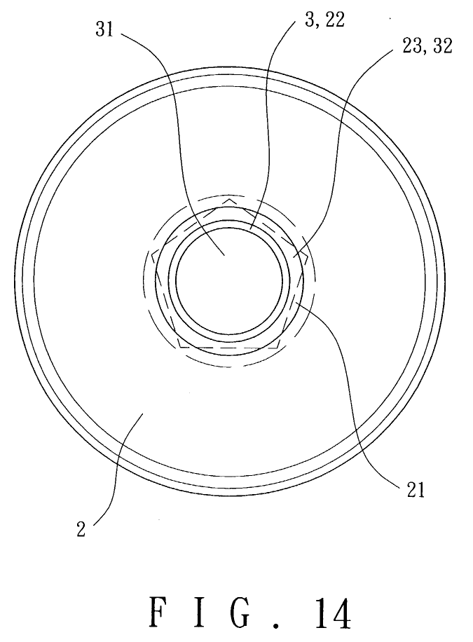

The axle tube 3 is made of plastic or metal and has an axial hole 31. At least one positioning portion 32 (two in this embodiment) is provided on an end of the axle tube 3 for engaging with the associated engaging portion 23 on the underside of the casing 2. In this embodiment, an extension 35 extends radially outward from a lower end of the axle tube 3 and is securely engaged with the countersink 24 of the casing 2. In this embodiment, each positioning portion is in the form of a longitudinal rib 32 on an outer periphery of the axle tube 3. Each longitudinal rib 32 of the axle tube 3 is engaged in the associated longitudinal groove 23 of the casing 2, thereby securely positioning the axle tube 3 in the base 21 of the casing 2, as shown in FIG. 13. If necessary, bonding agent can be used to improve the engagement between the axle tube 3 and the casing 2. Alternatively, tight fitting can be used.

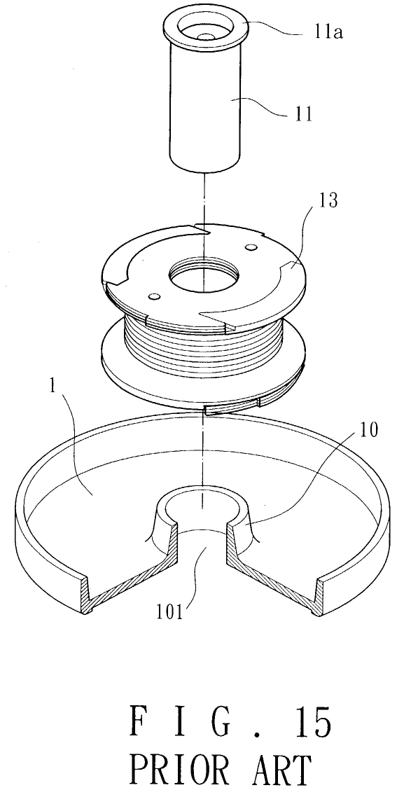

Referring to FIG. 14, after the axle tube 3 is engaged with the base 21, a conventional circuit board 12 is mounted around the base 21, and a conventional stator 13 is mounted around the axle tube 3. Further, a conventional bearing 14 and the above-mentioned support member 34 are mounted in the axial hole 31 of the axle tube 3. Further, a flange 33 can be formed on top of the axle tube 3 to prevent the stator 13 from being disengaged from the axle tube 3 and to provide a more reliable positioning effect for the axle tube 3.

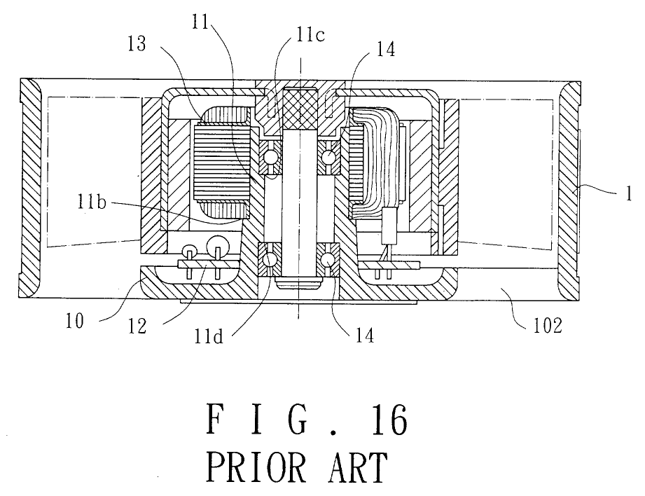

FIGS. 15 and 16 show a fifth embodiment of a combination of a base and an axle tube in accordance with the present invention, wherein like reference numerals designate like elements.

The fifth embodiment of the present invention includes a casing 2 and an axle tube 3. The casing 2 includes a base 21 projecting from a general plane of the casing 2 and extending along an axial direction perpendicular to the general plane. The base 21 has an axial hole 22. The casing 2 further has a countersink 24 in an underside thereof, the countersink 24 surrounding the axial hole 22 of the base 21. The countersink 24 is non-circular, preferably elliptic, triangular, square, rectangular, pentagonal, polygonal, etc. In this embodiment, the countersink 24 is pentagonal.

The axle tube 3 is made of plastic or metal and has an axial hole 31. At least one positioning portion 32 is provided on an end of the axle tube 3 for engaging with the engaging portion 23 on the underside of the casing 2. In this embodiment, an extension 35 extends radially outward from a lower end of the axle tube 3 and is securely engaged with the countersink 24 of the casing 2, thereby securely positioning the axle tube 3 in the base 21 of the casing 2 without the risk of rotational movement of the axle tube 3 relative to the casing 2, as shown in FIG. 16. If necessary, bonding agent can be used to improve the engagement between the axle tube 3 and the casing 2. Alternatively, tight fitting can be used.

As apparently clear from the above description, the positioning portion 32 of the axle tube 3 is securely engaged with the engaging portion 23 of the casing 2. When an axle tube of different inner diameter or length is required, only an additional mold for the axle tube is required. It is not necessary to manufacture a mold for the whole casing. The overall cost for production is thus reduced.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

1. A combination of a base and an axle tube for a fan motor, the combination comprising:
a casing including a base extending therefrom, the base having an axial hole, at least one engaging portion being defined in an underside of the casing; and
an axle tube including an axial hole, the axle tube further including at least one positioning portion on an end thereof, the axle tube being extended through the axial hole of the base, with said at least one positioning portion of the axle tube being engaged with said at least one engaging portion of the base; and
a support member inserted into the axial hole of the axial tube, said support member including an outer circumference adapted to securely engage with an inner surface of said at least one positioning portion of the axle tube, thereby preventing said one positioning portion of the axle tube from disengaging from said at least one engaging portion of the base.

2. The combination of a base and an axle tube for a fan motor as claimed in claim 1, wherein said at least one engaging portion of the casing is a groove, and wherein said at least one positioning portion of the axle tube includes a hook.

3. The combination of a base and an axle tube for a fan motor as claimed in claim 1, wherein said at least one engaging portion of the casing is a groove, and wherein said at least one positioning portion of the axle tube is a resilient hook rod having a hook.

4. (Canceled).

5. (Canceled)

6. A combination of a base and an axle tube for a fan motor, the combination comprising:
a casing including a base extending therefrom, the base having an axial hole, at least one engaging portion being defined in an underside of the casing;
an axle tube including an axial hole, the axle tube further including at least one positioning portion on an end thereof, the axle tube being extended through the axial hole of the base, with said at least one positioning portion of the axle tube being engaged with said at least one engaging portion of the base;
a support member inserted into the axial hole of the axial tube said support member including an outer circumference adapted to securely engage with an inner surface of said at least one positioning portion of the axle tube thereby preventing said one positioning portion of the axle tube from disengaging from said at least one engaging portion of the base,
wherein the casing further has a countersink in the underside thereof, the countersink surrounding the axial hole of the casing, at least one protrusion projecting from a peripheral wall delimiting the countersink and extending radially inward to form said at least one engaging portion, an extension extending radially outward from the end of the axle tube, at least one positioning portion being in the form of a notch in the extension

7. (Canceled)

8. The combination of a base and an axle tube for a fan motor as claimed in claim 1, wherein at least one longitudinal groove is defined in an inner periphery delimiting the axial hole of the base, and wherein at least one longitudinal rib is formed on an outer periphery of the axle tube and engaged in said at least one longitudinal groove.

9. The combination of a base and an axle tube for a fan motor as claimed in claim 1, wherein said at least one engaging portion of the casing is non-circular, and wherein said at least one positioning portion of the axle tube is configured complimentary to said at least one engaging portion of the casing.

10. The combination of a base and an axle tube for a fan motor as claimed in claim 9, wherein said at least one engaging portion of the casing is selected from the group consisting of elliptic, triangular, square, rectangular, pentagonal, and polygonal configurations.

11. The combination of a base and an axle tube for a fan motor as claimed in claim 1, wherein said at least one positioning portion of the axle tube and said at least one engaging portion of the casing are engaged with each other through tight fitting.

12. The combination of a base and an axle tube for a fan motor as claimed in claim 1, wherein said at least one positing portion of the axle tube and said at least one engaging portion of the casing are bonded with each other by a bonding agent.

13. The combination of a base and an axle tube for a fan motor as claimed in claim 1, wherein the axle tube is made of plastic or metal.

14. The combination of a base and an axle tube for a fan motor as claimed in claim 1, wherein the axle tube includes a flange on another end thereof.
